(19) United States
(12) Patent Application Publication
(10) Pub. No.: US 2016/0125088 A1
(43) Pub. Date: May 5, 2016

(54) DATABASE REGISTRATION

(71) Applicant: REWARD TECHNOLOGY LIMITED, London (GB)

(72) Inventor: Paul Daniel Sheedy, Essex (GB)

(73) Assignee: REWARD TECHNOLOGY LIMITED, NORTHAMPTON (GB)

(21) Appl. No.: 14/889,965

(22) PCT Filed: May 19, 2014
(86) PCT No.: PCT/GB2014/051526

§ 371 Date: Nov. 9, 2015

(30) Foreign Application Priority Data
May 20, 2013 (GB) 1309088.1

(51) Int. Cl. G06F 17/30; G06Q 30/02; G06K 7/10; G06K 19/04; G06K 19/06

(52) U.S. Cl. CPC G06F 17/30879; G06K 19/045; G06K 19/06028; G06K 19/06037; G06K 19/06187; G06K 7/10237; G06K 7/10861; G06Q 30/0226; G06F 17/30528; G06F 17/30864

(57) ABSTRACT

For database user registration a card is provided carrying an identification and a matrix barcode, wherein the matrix barcode stores the identification and a link to an online registration page of a database associated with an issuer of the card. The card may be used in combination with a smartphone for user registration into a database of e.g. a retailer's loyalty card scheme.

### FIELD OF THE INVENTION

This invention relates to a card for user identification and for facilitating entry of information into a database, to a mobile device, the combination of a card as aforesaid and a mobile device and an issuer data processor configured for interaction with the card and mobile device.

### BACKGROUND TO THE INVENTION

Retailers face a major issue with the data integrity of their customers signed into databases e.g. loyalty programmes. The issues fall into several categories. Retailers that give loyalty cards with no application form to fill in, those that give loyalty cards with an application form that can be filled in at any time and others that require the customer to fill in online. In many of these options there is little motivation for the customer to fill in details and post the application form in or to log on and complete the requested information. The decline of loyalty cards has been discussed over the last few years in the context of increasing mobile phone use. However the reality is that this decline has not occurred and with the global financial turbulence retailers have seen customer becoming much more price sensitive and more inclined take up offers and to use coupons.

Retailers who have had insight on their customers through deep level clean data have managed to adjust their businesses to the market conditions. The data on customer transactions is collected at the till as customers complete having their items scanned. The customer's loyalty card is scanned and the link between the card and those items being purchased is matched. The historic transactions allow retailers to build very clear views on customer's price sensitivity, promotional pull in each and every category in which they shop.

There is a clear increase in the number of people with Smartphones and many now have automatic fill in of forms software. With this in mind we have developed a solution to make it much easier for customers to get their loyalty card data correctly matched to their contact details.

### SUMMARY OF THE INVENTION

Loyalty cards with most retailers contain a barcode which has a unique number assigned to it. It is now proposed to add a second identification to the card. This may be a QR code which may be designed to allow the customer to photograph it with their smartphone. This QR code will take the customer to an online site of the retailer and into the online loyalty card registration section where the loyalty card number will be populated either manually or automatically using data pre-stored in the smartphone. The customer may then be prompted to complete other information or auto registration of data associated with the Smartphone may be filled in and a confirmation then ticked by the customer.

This solution helps to ensure that the loyalty card number is registered correctly to the phone through the app that has been downloaded on photographing the QR code on the loyalty card.

In one aspect the invention provides a user card carrying an identification and a matrix barcode, wherein the matrix barcode stores the identification and a link to an online registration page of a database associated with an issuer of the card. The QR code may also contain the RFID unique ID of the card if it has that feature.

The invention further provides the combination of a mobile device, a camera forming part of the mobile device and matrix barcode recognition software stored in the mobile device and configured to recognise an identification and a link and transmit the link to an issuer website for initiating transmission of the registration page and a card as aforesaid.

The invention further provides a data processor having a database e.g. a retailer loyalty database linked to a website, the website having a data registration page configured for communication the mobile device as aforesaid.

### BRIEF DESCRIPTION OF THE DRAWINGS

How the invention may be put into effect will now be described by way of example only with reference to the accompanying drawings in which:

FIG. 1 shows a face of a loyalty card;

FIG. 2 shows successive steps in the use of the loyalty card in association with a smartphone; and

FIG. 3 is a flowchart showing operation of the loyalty card in slightly greater detail.

### DETAILED DESCRIPTION OF PREFERRED EMBODIMENT

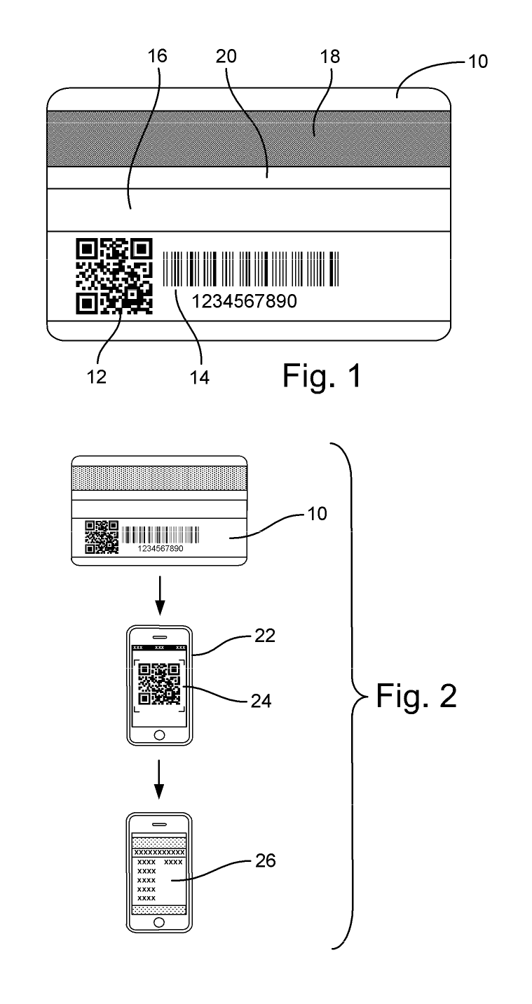

FIG. 1 shows a card 10 min ISO/IEC 7810 format of size 85.60×53.98 mm (3.370×2.125 in) with rounded corners of radius of 2.88-3.48 mm. This card format is commonly used for banking cards (ATM cards, credit cards, debit cards, etc.) and is also used for driving licences in many countries as well as retail loyalty card. It will be appreciated that different dimensions are possible but for reasons of consumer familiarity acceptability the standard dimensions are preferred.

The card 10 may also carry a matrix barcode 12 e.g. a QR code which in this instance stores an identifier and a URL linking to a registration webpage of a card issuer's website. The matrix barcode e.g. QR code may be printed directly on the card or may be printed onto a sticker e.g. of paper or plastics which may be adhered to the card and removed after registration. The card may also carry a one-dimensional barcode 14 and/or a legible identifier, a signature strip 16 and/or a magnetic strip 18 separated from the signature strip by gap 20. A further possibility is that the card may have the profile of a mini-keyfob-card e.g. of dimensions about 2.5 cm by 5 cm, or it may have any size dictated by user preferences such as smaller keyfob versions. The card is usually of a suitable thermoplastics material in printable plastics sheet sheet form e.g. polyvinyl chloride, polyvinyl chloride acetate, Telsin (PPG Industries or ABS (acrylonitrile-butadiene-styrene) and may be a laminated structure, die-cut to size and if appropriate embossed. Options for printing the matrix barcode and other variable information include thermal printing and dye sublimation printing. Telsin in particular is a microporous synthetic sheet material which is polyolefin-based with 60% of its weight comprised of non-abrasive filler and 65% of its volume comprised of air. Printing processes for Telsin include offset, monochrome laser, color laser, flexography, gravure, letterpress, intaglio, thermal transfer, ink jet, and screen-printing processes.

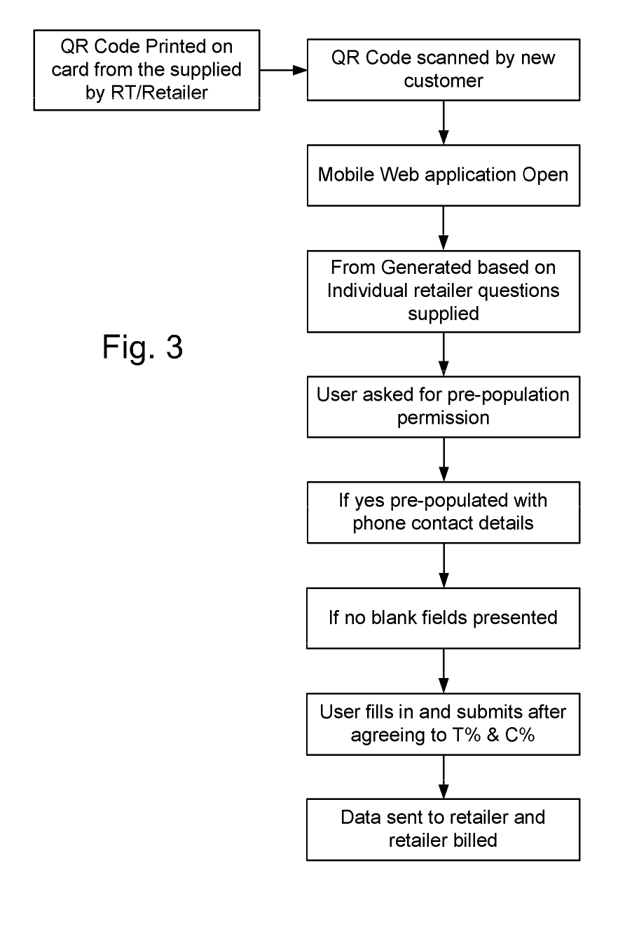

FIG. 2 shows a smartphone 22 having a QR recognition app downloaded into it and photographing the barcode 12 to provide onscreen image 24. Use of the recognition app causes a website of the card issuer e.g. a large retailer to be accessed and a registration page 26 to appear. Thereafter the registration page is populated either manually or using pre-stored data, and the data and the identifier are returned to the card issuer website. The process is shown in more detail in FIG. 3 which is believed self-explanatory. The mobile device may be a smartphone, tablet or any other form of digital device that allows web communication. The issuer website registration page may have the capability for entering existing loyalty card number for maintaining historical data.

1. A user card carrying an identification and a matrix barcode, wherein the matrix barcode stores the identification and a link to an online registration page of a database associated with an issuer of the card.

2. The card of claim 1, further comprising a linear barcode carrying the identification.

3. The card of claim 1, further comprising a magnetic strip recorded with the identification.

4. The card of claim 1, further comprising a signature panel.

5. The card of claim 1, which is of size 85.6 mm×54 mm.

6. The card of claim 1, wherein the matrix barcode is a QR code.

7. The card of claim 1, wherein the identification is a unique serial number for the card.

8. The card of claim 1, wherein the matrix barcode is carried on a removable label adhesively attached to the card.

9. The card of claim 1, wherein the matrix barcode is a direct print onto the card.

10. The card of claim 1, wherein the card is of printable thermoplastics sheet.

11. The card of claim 1, which further has RFID capability.

12. The card of claim 11, wherein the matrix barcode contains an RFID identifier.

13. A combination of:
a mobile device including a camera, the mobile device further including matrix barcode recognition software stored in the mobile device configured to recognise an identification and a link and transmit the link to an issuer website for initiating transmission of the registration page; and
a user card carrying an identification and a matrix barcode, wherein the matrix barcode stores the identification and a link to an online registration page of a database associated with an issuer of the card.

14. The combination of claim 13, wherein the link contains the identification, the retailer ID, and the RFID ID.

15. A data processor having a database linked to a website, the website having a data registration page configured for communication the mobile device of claim 13.

16. The data processor of claim 15, wherein the database is a retailer loyalty database.

17. The data processor of claim 16, wherein the website has the capability for entering existing loyalty card number for maintaining historical data.
